(19) United States
(12) Patent Application Publication
(10) Pub. No.: US 2010/0076721 A1
(43) Pub. Date: Mar. 25, 2010

(54) Dynamic Sizing Apparatus, System, and Method of Using the Same

(75) Inventors: Clifford Simms, Boulder, CO (US); Waldean Schulz, Boulder, CO (US)

Correspondence Address: WALDEAN A. SCHULZ;CONCEPTUAL ASSETS, INC., 440 JAPONICA WAY, BOULDER, CO, 80304-1712, US

(73) Assignee: Crucial Innovation, Inc., Boulder, CO (US)

(21) Appl. No.: 12/553,876

(22) Filed: Sep. 3, 2009

Related U.S. Application Data
(60) Provisional application No. 61/099,490, filed on Sep. 23, 2008.

(51) Int. Cl. G06F 19/00; G01B 11/00

(52) U.S. Cl. 702/155; 356/625

(57) ABSTRACT

Described are an automated system, an apparatus, and a method adapted to tracking and dynamically measuring locations in a volume for determining a size and a position of a body during a performance of a repetitive motion, such as in using sporting equipment. The sporting equipment may be a bicycle, and the body may be a cyclist. The apparatus comprises a plurality of markers attached to the body, a three-dimensional marker tracking system, and a processing unit. The apparatus, system, or method computes a dimensional statistic from computed measurements of all strokes of at least two strokes included in a period of time of the repetitive motion.

### CROSS-REFERENCE TO RELATED APPLICATIONS

This a US non-provisional patent application claiming priority to the provisional patent application filed by Simms, et al, on Sep. 23, 2008, with Ser. No. 61/099,490.

### FIELD OF INVENTION

This invention relates to an automated method and system for tracking and dynamically measuring locations in 3-dimensional space to determine one or more dimensions or one or more positions of a body during the performance of a repetitive motion.

### BACKGROUND

Prior art optical-based measurement systems have been employed to measure or analyze motion of a body-including a performance of a repetitious action during some period of time. One example is the Motus system of Vicon Motion Systems (Centennial, Colo.), which employs retro-reflective markers attached to the joints or other locations of a human body and viewed by one or more video cameras. Some systems can track and analyze the motion in 3 dimensions (3-d).

For example, prior art systems may search for a single maximum extension angle of a joint during a motion recording period, and upon conclusion of the recording period, typically report only a one isolated maximum extension angle which was captured. This may be because the system is not specialized for recording and analyzing repetitive—or cyclical—motion. Furthermore, a prior art system may not actually estimate—such as through interpolation—what the actual maximum was, but only the maximum angle of all the body positions which were captured and recorded by the system. That is, motion capture systems acquire and record only discrete body positions, not continuous motion of the body, so that the actual maximum angle in generally may have occurred between two consecutive acquired samples. Other examples include measuring the minimum or flexion angle of a joint, the angle of the joint at some point in a repetitive stroke, a minimum or maximum distance between points on a body, or a distance between body points based on the recorded point locations acquired at discrete instants in time.

### BRIEF SUMMARY OF THE INVENTION

Described herein are a system, an apparatus, and a method, among other embodiments, adapted to obtain dynamic sizing measurements. As used herein, the term “dynamic sizing measurements” refers to one or more body dimensions taken during the performance of a repetitive—or cyclic—action. Dynamic sizing measurements may be used in a variety of applications. One application that employs dynamic sizing measurements is the fitting of sporting equipment to specific users. One type of sporting equipment which may use dynamic sizing measurements to properly fit the equipment to a specific user is a bicycle. It is to be appreciated that the systems, apparatus, methods, and other embodiments described herein may be applied to other sporting equipment and non-sporting equipment. Furthermore, the systems, apparatus, methods, and other embodiments described herein may be applied in non-fitting applications such as, but not limited to, other biomechanical or healthcare applications.

One embodiment comprises a method of taking measurements of a cyclist 1 situated on a bicycle 2 while the cyclist 1 is operating the bicycle 2 in a stationary position—such, as, but not limited to, on a trainer 3, as shown in FIG. 1. In order to obtain dynamic sizing measurements, a plurality of markers 10f, 10a, 10k, 10h, 10s, 10w may be placed on the body of the cyclist 1. In one embodiment, the placement of markers 10a-10w is determined by the equipment that is being fit for the user. For example, in FIG. 1, six markers 10a-10w are located on the cyclist's body parts in order to calculate various angles between certain body parts during pedaling of the bicycle. However, it is contemplated that more than or less than six markers 10a-10w may be used.

In a method called Stroke Intelligence, the method—or an apparatus or system implementing the method—determines at least one dimensional statistic such as an average minimum and/or an average maximum angle or distance over a plurality of strokes—or cycles—of repetitive motion. The minimum or maximum dimensional statistic is not based on a single measurement location at a single instant of time within a single stroke, but the dimensional statistic is really an average of the minimal or an average of the maximal dimensions computed from the marker locations determined during a plurality of the strokes of the repetitive motion.

The motion may be represented by a sequence of coordinates and corresponding timestamps for each marker, where the coordinates represent the locations, and where the timestamps represent the instants in time when the locations were determined.

### DESCRIPTION OF THE DRAWINGS

The accompanying drawings, which are incorporated herein and form a part of the specification, illustrate a preferred embodiment of the present invention and, together with the description, serve to explain the principle of the invention.

FIG. 1 is a simplified perspective view of the major components of this invention.

FIG. 2 is a side view illustrating measurement of an angle formed at the knee of a cyclist on a bicycle.

FIG. 3 is a simplified diagram illustrating interpolation of discrete locations.

FIG. 4 provides an example of a display of measurements computed by an embodiment.

Table 1 lists various possible computed measurements using locations of markers measured by the system.

### DETAILED DESCRIPTION

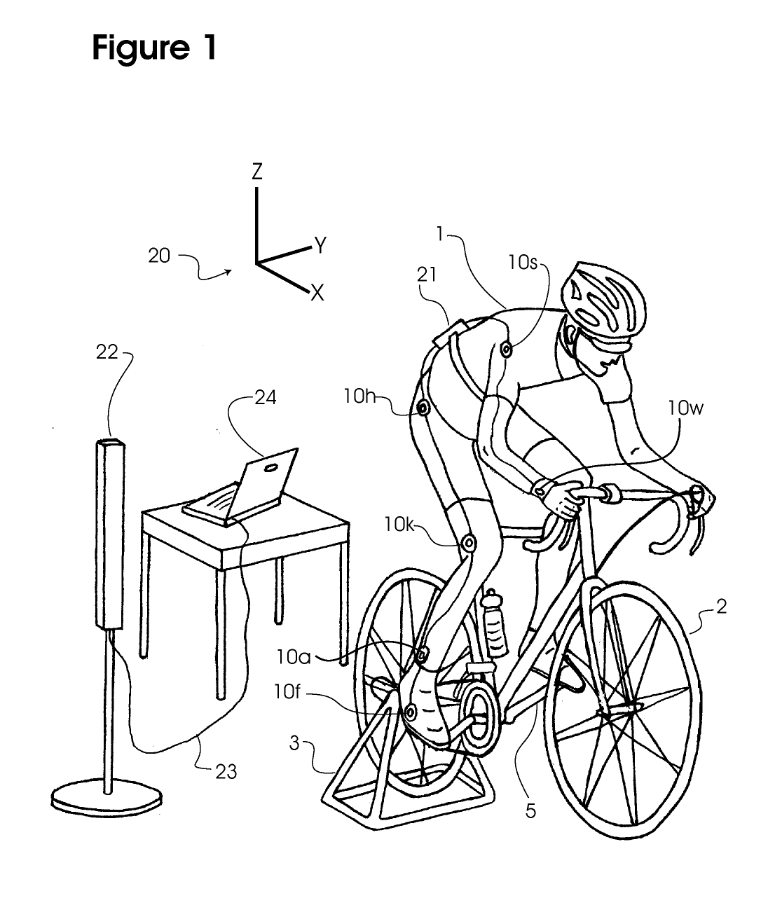

One embodiment uses an optical measurement system. With respect to FIG. 1, for example, one optical measuring system comprises markers 10a-10w adapted to emit light which may be received by a reception unit 22. One example of a reception unit 22 may be the 3DCreator system of Boulder Innovation Group (Boulder, Colo.). One reception unit 22 may have a plurality of reception ports in order to triangularly determine the source of light emitted by each marker 10a-10w. The reception ports may be adapted to determine angles of the light source within a three-dimensional space. One reception unit 22 may be adapted to receive rays of light from each of a plurality of light-emitting diode (LED) markers 10a-10w. LED markers 10a-10w may receive power through a power and synchronization cable from the reception unit 22. Alternatively, battery-powered LED markers 10a-10w may be flashed upon wirelessly-transmitted signals to a receiver 21 using radio or infrared transmission.

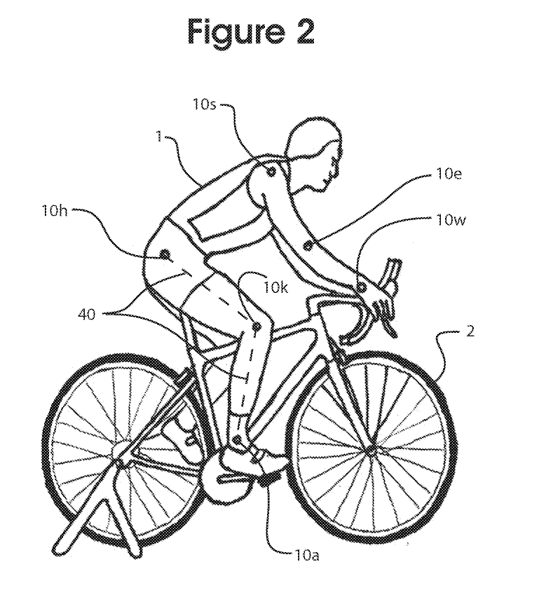

In one embodiment, each marker 10a-1 0w is adapted to sequentially flash and emit light. For example, as shown in FIGS. 1 and 2, a first marker may comprise a hip marker 10h, a second marker may comprise a knee marker 10k, and a third marker may comprise an ankle marker 10a. Together, these three markers 10h, 10k, 10a may be so affixed onto the cyclist to indicate a knee extension angle 40 in 3-dimensional space.

In one embodiment, it may be advantageous to calculate a maximum knee extension angle in order to properly fit a bicycle 2 to a cyclist 1. In order to calculate an accurate maximum knee extension angle 40, the maximum knee extension angle 40 is calculated for each stroke in a series of consecutive strokes, wherein, a single stroke—or cycle of motion may be characterized as a complete revolution of a pedal crank 5. In determining one knee extension angle 40, the first marker 10h may emit light for 3.5 ms at a first time, the second marker 10k may emit light for 3.5ms at a second time, wherein the second time follows the first time, and the third marker 10a may emit light for 3.5 ms at a third time, the third time immediately following the second time. Longer or shorter light emitting periods may be used, the markers may emit light in some other order, and/or additional markers 10f, 10s, 10w may sequentially emit light. In one embodiment, the location of these markers 10a-10w during a stroke is digitized by the reception unit 22 and then a signal characterizing a location for each marker 10a-10w is sent via a cable 23 to a processing unit 24. One processing unit 24 may be a laptop, some other personal computer, or a stand-alone embedded computer. The processing unit 24 is adapted to acquire the marker location data received from the reception unit 22 and process the acquired data into 3-dimensional coordinate values. These 3-d coordinate values may then be used for further processing and data manipulation by the processing unit or a separate computer.

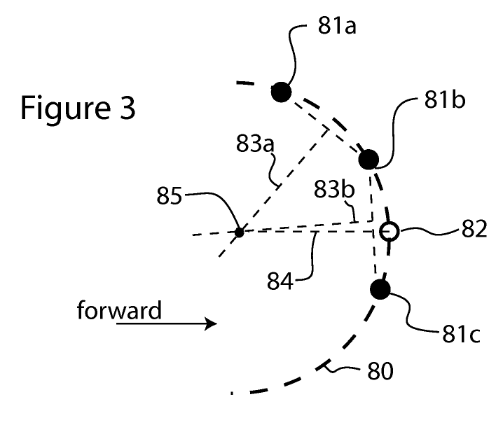

In a process called “stroke intelligence”, further explained below, one embodiment may take sets of measurements from each stroke and average together the corresponding measurements. In one embodiment, a system may have knowledge of the expected repetitive movements of the cyclist and thus can respond to specific key measurement positions of the cyclist. For example, a pedal and a foot coupled to the pedal may generally follow an approximately circular pattern as diagrammed in FIG. 3. However, a marker 10f coupled to the foot may only momentarily emit light at a specified, optimal point in time. Therefore each marker 10a-10w is not continuously providing location data to the reception unit 20. In particular, the markers 10a-10w may not emit light exactly at a desired measurement position of the cyclist. Nevertheless, the location of the markers 10a-10w in-between the light emitting positions of each stroke may be estimated-based on the known repetitive motion. For example, if the coordinates and the corresponding timestamps of three or more consecutive locations 80a,80b,80c of a given marker 10f are known for corresponding instants in time, a continuous circle or a polynomial function may be fit to these locations of the marker 10f, where the coordinates of the locations are a function of the time of the timestamps. For 2- or 3-dimensional coordinates, each coordinate component (X, Y, or Z) may be described by a single real-valued function. Then, all points on the circle or function correspond to estimated locations at various instants in time. So given an instant in time, an estimated location is defined. Conversely, given a location, a corresponding instant of time may be estimated.

Furthermore, the locations of all the markers 10a-10w may be estimated for one and the same specific instant in time using the same technique. Then, the angle formed by any three of the markers 10a-10w will be, in effect, determined accurately from the three locations for the same given instant in time.

All motion detection devices, 3D and video, have a set acquisition frequency and therefore do not capture all points continuously. One feature of the present invention is the ability to obtain sufficiently accurate estimates of locations, distances, and/or angles even when the reception unit 22 does not capture marker locations at the optimal time within a given stroke. The estimates may be reliably obtained through software interpolation based on a set of measurements acquired before and after the optimal time. For example, due to the known application-specific movements of the cyclist, such as the foot being attached to the pedal, and the pedal being attached to the crank 5, the foot is known to move approximately in a circle and therefore, more accurate foot marker locations may be estimated. Other body parts may repetitively move along 3-d geometrical curves other than a circle. This system of interpolation may be known as “Stroke Intelligence”.

FIG. 3 illustrates how a circle may be used to interpolate between three consecutive measured locations 81a,81b,81c of a marker such as marker 10f. The perpendicular bisectors 83a and 83b of the line segments joining the locations 81a and 81b and joining the locations 81b and 81c may be respectively computed using well-known analytic geometry. The intersection of the bisectors is the center 85 of the circle 80 which passed through the three points. Then the most-forward location 82 of the marker 10f, for example, may be estimated as being at the end of the radial 84 from the center 85 which is parallel to the forward direction of the bicycle 2. Alternatively, given that the acquisition times of the locations 81a,81b,8c are known, standard linear interpolation may be used to estimate the location of the marker 10f at some specific time between the acquisition times of the locations 81a and 81c. Estimates of the location of the marker at times not within that range of acquisition times may not be accurate. The same interpolation technique may be used for all markers 10a-10w, as needed.

Instead of a circle, some other curve, such as a parabola or other polynomial may be used to approximate the continuous 3-d path of a marker and estimate an extreme location or to estimate the location of the marker at some specified moment.

In some embodiments, it may be preferred to obtain more than just the locations of markers on a cyclist's body parts. For example, collections of body positions that make up cyclically-changing angles are desired. A maximum or minimum of such an angle for each stroke may be estimated, such as the angle formed by markers 10h, 10k, 10a, which may represent the knee angle 40 formed by the thigh and calf. The maximum angles formed by marker locations—as calculated above—spanning a plurality of strokes may be averaged together. That is, one maximum angle may be estimated for each of the plurality of repetitive strokes. Then the average of the estimated maximum angles may be used as a substantially reliable and accurate measurement of the cyclist's knee extension angle. Similarly, the estimated minimum angles for all strokes may be averaged together to provide a substantially accurate measurement of the cyclist's knee flexion angle. Likewise, the measurement of an angle or a distance at a given point in each repetitive stroke may be combined with the corresponding measurements of all other strokes to form an average or consensus value.

Further dimensional statistics besides average minima or average maxima—such as ranges, means and standard deviations of locations, distance, or angles—may be collected over a period of time. The statistics may be collected for any or all angles defined by three markers or for any or all distances between two given markers. Statistics may be gathered similarly for other measureable, dimensional attributes, such as area, volume, power output, or speed.

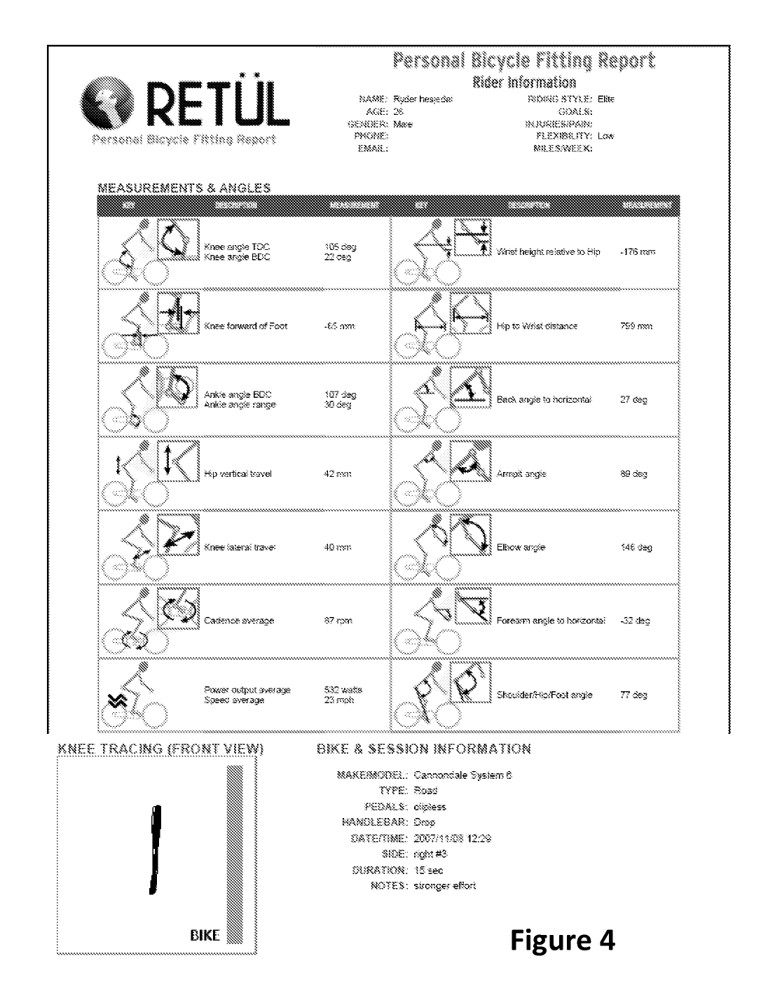

An example of Stroke Intelligence computation is measuring the knee extension angle 40. Nevertheless, as shown in Table 1 and FIG. 4, the knee extension angle 40 is only one of many measurement statistics that Stroke Intelligence may be used to obtain and report. During a 15 second timing period a cyclist may take about 18-20 full strokes of motion. Prior art systems may search for a single maximum knee extension angle 40 during the full 15 second recording time, and upon conclusion of the recording period, report the single maximum extension angle 40. In that case, a single, anomalous or inaccurate measurement may cause an erroneous maximum angle. Conversely, in one embodiment of the current invention, the system watches each stroke, estimates the maximum knee extension angle 40 for that stroke using an interpolation function, and then the system saves the angle for later reporting. The system repeats this estimation for each stroke. In order to obtain the true maximum angle for each stroke, the system checks each stroke to find an interpolated maximum, since more often than not the system will not really acquire data at the exact moment of maximum extension. The system interpolates marker locations and estimates therefrom the maximum extension angle which actually did occur and saves the value of the angle. This interpolation and estimation may be performed for each of many strokes during a period of time. Upon the end of the period, the system is adapted to immediately compute the average of all the saved estimated angles and report the average as the value of the cyclist's mean knee extension angle 40. Immediately-averaged measurements provide more accurate sizing measurements compared to providing a single measurement over a period of time, because the averaged positions account for small anomalies due to normal minor variations of body position during repetitive motion. A single measurement fails to guard against any anomalies and minor variations or for the effect of some “outlier” measurement captured when the cyclist sneezed. Prior art systems may fail to perform the automatic, immediate real-time calculation of averaged measurements.

Distance dimensions as well as angles may be estimated using Stroke Intelligence, and dimensional statistics may be computed therefrom. For example, it may be useful to measure the horizontal distance of the foot with respect to the knee when the foot is at the most-forward position. That is when the pedal crank is at the “3 o'clock” angle for the right side of the cyclist, or at the “9 o'clock” angle for the left side. Few, if any, of the locations of the foot marker may have been acquired with the foot exactly in this location. However, stoke intelligence can use three or more foot locations 81a,81b,81c of the marker 10f to estimate when and where the foot marker 81c would have reached its most forward location 82 during each stroke by using non-linear circular or polynomial functions to estimate the minimum or maximum of the function. Finding a minimum or maximum of a function is a well known method in elementary calculus.

Incorporated into the calculations is “marker intelligence”. This means that the system knows which marker is which. In other words, the system knows that light received by the reception unit 20 at a certain instant in time applies to a specific marker 10. In prior art video systems, a video system operator would have to manually seek each marker and calculate the desired measurement for each stroke and then average the measurements together. The prior art method ignores the problem of interpolation when no captured video frame aligns with the desired cyclist position. Further inaccuracy is introduced by the unreliability of manually selecting the desired markers repeatably on a small computer screen.

The description above has assumed that the locations—specifically the location coordinates—of the markers and the measurements based on the locations are within a 3-dimensional space. The system, apparatus, and method can be equally applied to locations and measurements within a 2-dimensional space.

Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many other variations, modifications, and alternative constructions fall within the scope and spirit of the disclosed invention as expressed in the claims.

TABLE 1

| Physical | Measurement | Markers | |
|---|---|---|---|
| Property | Title | Involved | Measurement Definition |
| angle | Knee Angle | Hip, | The average of each stroke's minimum |
| | Flexion | Knee, | angle in 3D, defined by the hip, knee, and ankle. |
| | | Ankle | |
| angle | Knee Angle | Hip, | The average of each stroke's maximum |
| | Extension | Knee, | angle in 3D, defined by the hip, knee, and |
| | | Ankle | ankle |
| angle | Back Angle | Hip, | The average of the 3D acute included |
| | | Shoulder | angle defined by the hip to shoulder line |
| | | | segment and the horizon, for all body |
| | | | measurement sets. |
| angle | Armpit Angle | Hip, | The average of the 3D included angle |
| | to Elbow | Shoulder, | defined by the hip, shoulder, and elbow for |
| | | Elbow | all body measurement sets. |
| angle | Armpit Angle | Hip, | The average of the 3D included angle |
| | to Wrist | Shoulder, | defined by the hip, shoulder, and wrist for |
| | | Wrist | all body measurement sets. |
| angle | Elbow Angle | Shoulder, | The average of the 3D included angle |
| | | Elbow, | defined by the shoulder, elbow, and wrist |
| | | Wrist | for all body measurement sets. |
| angle | Forearm | Elbow, | The average of the 3D acute included |
| | Angle | Wrist | angle defined by the elbow to wrist line |
| | | | segment and the horizon for all body |
| | | | measurement sets, where positive angle |
| | | | represent the wrist higher than the elbow. |
| angle | Ankling | Knee, | The average of each stroke's difference |
| | Range | Ankle, | between the maximum and minimum 3D |
| | | Foot | included angle defined by the knee, ankle, |
| | | | and foot. |
| angle | Ankle | Knee, | The average of each stroke's maximum |
| | Plantarflexion | Ankle, | 3D included angle defined by the knee to |
| | | Foot, | ankle line segment and the foot to heel |
| | | Heel | line segment. |
| angle | Ankle | Knee, | The average of each stroke's minimum 3D |
| | Dorsiflexion | Ankle, | included angle defined by the knee to |
| | | Foot, | ankle line segment and the foot to heel |
| | | Heel | line segment. |
| angle | Hip Angle | Knee, | The average of each stroke's minimum 3D |
| | Closed | Hip, | included angle defined by the knee, hip, |
| | | Shoulder | and shoulder. |
| angle | Hip Angle | Knee, | The average of each stroke's maximum |
| | Open | Hip, | 3D included angle defined by the knee, |
| | | Shoulder | hip, and shoulder. |
| angle | Knee Travel | Knee | The acute included angle in the frontal |
| | Tilt | | plane between the best fit axis of the |
| | | | points of the knee during the recording |
| | | | and the vertical axis. |
| ang_velocity | Cadence Ave | Foot | The average calculated number of strokes |
| | | | per minute defined by the foot for all body |
| | | | measurement sets. |
| ang_velocity | Cadence Max | Foot | The maximum calculated number of |
| | | | strokes per minute defined by the foot of |
| | | | the recording time. |
| power | Power Output | Button | The average calculated power or user |
| | Ave | | input power during the recording time. |
| power | Power Output | Button | The maximum calculated power during the |
| | Max | | recording time. |
| velocity | Speed Ave | Button | The average calculated rear wheel speed |
| | | | during the recording time. |
| velocity | Speed Max | Button | The maximum calculated rear wheel |
| | | | speed during the recording time. |
| distance | Knee Forward | Knee, | The average of each stroke's difference |
| | of Foot | Foot | between the horizontal locations of the |
| | | | knee and foot when the foot is in the most |
| | | | forward position where a positive number |
| | | | represents the knee being more forward |
| | | | then the foot. |
| distance | Hip Vertical | Hip | The average of each stroke's difference |
| | Travel | | between the maximum and minimum |
| | | | vertical position of the hip. |
| distance | Knee Lateral | Knee | The average of each stroke's difference |
| | Travel | | between the maximum and minimum |
| | | | lateral position of the knee. |
| distance | Hip to Wrist | Hip, | The average of the differences of the |
| | Vertical | Wrist | vertical position of the hip and wrist for all |
| | | | body measurement sets, where a positive |
| | | | number represents the wrist being higher |
| | | | than the hip. |
| distance | Hip to Wrist | Hip, | The average of the differences of the |
| | Horizontal | Wrist | horizonal position of the hip and wrist for |
| | | | all body measurement sets. |
| distance | Hip to Elbow | Hip, | The average of the differences of the |
| | Vertical | Elbow | vertical position of the hip and elbow for all |
| | | | body measurement sets, where a positive |
| | | | number represents the elbow being higher |
| | | | than the hip. |
| distance | Hip to Elbow | Hip, | The average of the differences of the |
| | Horizontal | Elbow | horizonal position of the hip and elbow for |
| | | | all body measurement sets. |
| distance | Hip Foot | Hip Foot | The average of the distances between the |
| | Lateral Offset | | lateral position of the hip and foot of each |
| | | | body measurement where a positive |
| | | | number represents the foot being further |
| | | | from the plane of the bicycle than the hip. |
| distance | Thigh Length | Hip, | The average of the 3D distances between |
| | | Knee | the Hip and Knee for all body |
| | | | measurement sets. |
| distance | Shin Length | Knee, | The average of the 3D distances between |
| | | Ankle | the Knee and Ankle for all body |
| | | | measurement sets. |

end of Table 1

We claim

1. An apparatus to compute a dimensional statistic for a body during performance of a repetitive motion, the repetitive motion including at least two strokes, comprising:
a plurality of markers affixed to the body;
a reception unit adapted to receive light from the plurality of markers and to determine a sequence of locations for each marker over a period of time, each location being associated with a discrete instant in time; and
a processing unit adapted to receive the sequence of locations and the associated instants in time for each marker during the period of time;
wherein the processing unit uses the sequence of locations and the discrete instants in time
to estimate the locations of a set of the plurality of markers all at a single given instant in time within each stroke of the at least two strokes,
to compute a measurement for each of the at least two strokes of the repeated strokes,
to compute the dimensional statistic for the computed measurements of all of the at least two strokes of the repetitive motion during the period of time, and
to report the dimensional statistic.

2. The apparatus of claim 1, wherein the body is a cyclist and the repetitive motion is pedaling a bicycle.

3. The apparatus of claim 1, wherein a marker of the plurality of markers is a light emitting diode.

4. The apparatus of claim 1, wherein the measurement is an angle defined by the estimated locations of three of the plurality of markers for a given instance of time.

5. The apparatus of claim 1, wherein the measurement is a distance between the estimated locations of two of the plurality of markers for a given instance of time.

6. The apparatus of claim 1, wherein the dimensional statistic is a dimension of the body.

7. The apparatus of claim 1, wherein the measurement is a maximum computed measurement within a single stroke of the at least two strokes.

8. The apparatus of claim 7, wherein the statistic is an average maximum, computed from a local maximum of each stroke of the at least two strokes.

9. The apparatus of claim 1, wherein the measurement is a minimum computed measurement within one stroke.

10. The apparatus of claim 9, wherein the statistic is an average minimum, computed from a local minimum of each stroke of the at least two strokes.

11. A system to compute a dimensional statistic of a cyclist while pedaling a bicycle, for a period of time spanning at least two strokes of a repetitive motion, comprising:
a plurality of markers affixed to the cyclist;
a reception unit adapted to receive light from the plurality of markers and to determine a sequence of locations for each marker over the period of time, each location associated with a discrete instant in time; and
a processing unit adapted to receive the sequence of locations and the associated instants in time for each marker during the period of time;
wherein the processing unit uses the sequence of locations and the discrete instants in time
to estimate the locations of a set of the plurality of markers all at a single given instant in time within each stroke of the at least two strokes,
to compute a measurement from the estimated locations within each stroke of the at least two strokes,
to compute the dimensional statistic for the computed measurements of all strokes of the at least two, and
to report the dimensional statistic.

12. The system of claim 11, wherein at least six markers of the plurality of markers are affixed on a foot, an ankle, a knee, a hip, a shoulder, and a wrist of the cyclist.

13. The system of claim 1 1, wherein the computed measurement is an angle defined by the estimated locations of three of the six markers.

14. The system of claim 13, wherein the angle is a knee angle defined by the locations of the markers affixed to the ankle, the knee, and the hip.

15. The system of claim 13, wherein the angle is an extension angle.

16. The system of claim 13, wherein the angle is a flexion angle.

17. The system of claim 1 1, wherein the computed measurement is a distance between the estimated locations of two of the markers of the plurality of markers.

18. A method of computing and reporting a dimensional statistic of a body during the performance of a repetitive motion during a period of time spanning at least two strokes of the repetitive motion, comprising:
determining, at discrete instants in time, locations for each marker of a plurality of markers affixed to the body;
estimating the locations of a set of the plurality of markers all at a single given instant in time within each stroke of the at least two strokes;
computing a measurement from the estimated locations for each stroke of the at least two strokes;
computing the dimensional statistic from the measurements computed for each stroke of the at least two strokes; and
reporting the dimensional statistic.

19. The method of claim 18, wherein the estimating of locations includes interpolating two or more locations of one marker of the plurality of markers, which locations were determined at different discrete instants in time.

20. The method of claim 18, wherein the computing of the measurement, for the each single stroke of the at least two strokes, computes an angle defined by three locations of the estimated locations.

21. The method of claim 20, wherein the computing of the angle computes a minimum angle defined by the three locations for all locations determined at instants of time within each single stroke of the at least two strokes.

22. The method of claim 20, wherein the computing of the angle computes a maximum angle defined by the three locations for all locations determined at instants of time within each single stroke of the at least two strokes.

23. The method of claim 18, wherein the computing of the measurement for the each stroke of the at least two strokes of the repeated strokes computes a distance defined by two of the estimated locations.

24. The method of claim 23, wherein the computing of the distance computes a minimum distance defined by the two locations for all locations determined at instants of time within a single stroke.

25. The method of claim 23, wherein the computing of the distance computes a maximum distance defined by the two locations for all locations determined at instants of time within a single stroke.

26. The method of claim 18, wherein the computing of the dimensional statistic computes an average measurement given the measurement for each stroke of the at least two strokes of the repeated strokes.
